(19) United States
(12) Patent Application Publication
(10) Pub. No.: US 2022/0277276 A1
(43) Pub. Date: Sep. 1, 2022

(54) Credit Card As a Foreign Exchange Market Card

(71) Applicant: Wells Fargo Bank, N.A., San Francisco, CA (US)

(72) Inventors: Srinivasan Madhavan, Hyderabad (IN); Ramanathan Ramanathan, Bellevue, WA (US); Seetha Gurunathan, Hyderabad (IN); Shanmukeswara Rao Donkada, Hyderabad (IN); Rameshchandra Bhaskar Ketharaju, Hyderabad (IN)

(21) Appl. No.: 16/164,410

(22) Filed: Oct. 18, 2018

Related U.S. Application Data
(60) Provisional application No. 62/727,620, filed on Sep. 6, 2018.

(51) Int. Cl. G06Q 20/10; G06Q 20/24; G06F 17/30

(52) U.S. Cl. CPC G06Q 20/10; G06Q 20/24; G06F 17/30312; G06Q 2220/00

(57) ABSTRACT

A method for using an existing credit card of an individual in a foreign country includes receiving a request to allocate an amount of money for use with the credit card in the foreign country. The foreign country in which the individual is to travel is identified. A collaborative bank in the foreign country is identified. The collaborative bank is a financial institution that can implement a virtual account for the individual. A request is sent to the collaborative bank to allocate the amount of money for the virtual account. The credit card is permitted to be used to make purchases in the foreign country using the amount of money allocated to the virtual account.

### BACKGROUND

Purchasing goods and services in foreign countries can be problematic for travelers. When local currency is required for the purchase of the goods or services, the traveler typically needs to obtain cash in the local currency. An exchange rate is commonly paid for the exchange to the local currency. Exchange rates can fluctuate, and exchange rate fees can be expensive.

When goods are purchased using a credit card of the traveler, the traveler typically has to pay a transaction fee for each purchase, in addition to dealing with exchange rates. Transaction fees for credit card purchases in foreign countries can tend to be expensive.

A forex card is a type of prepaid debit card that a traveler can use to make purchases in foreign countries. The prepaid card can be loaded with a specific amount of a foreign currency. However, exchange rate and other fees associated with forex cards can also be problematic.

### SUMMARY

Embodiments of the disclosure are directed to a method implemented on an electronic computing device for using an existing credit card of an individual in a foreign country, the method comprising: receiving a request to allocate an amount of money for use with the credit card in the foreign country; identifying the foreign country in which the individual is to travel; identifying a collaborative bank in the foreign country, the collaborative bank being a financial institution that can implement a virtual account for the individual; sending a request to the collaborative bank to allocate the amount of money for the virtual account; and permitting the credit card to be used to make purchases in the foreign country using the amount of money allocated to the virtual account.

In another aspect, a method implemented on an electronic computing device for using an existing credit card of an individual in a foreign country comprises: receiving a request to establish a virtual financial account for the individual in a bank associated with the electronic computing device in the foreign country, the bank being associated with a financial institution in a home country of the individual; receiving a request to allocate an amount of money in a local currency of the foreign country for the virtual financial account; allocating the amount of money in the local currency for purchases to be made using the credit card in the foreign country; receiving travel dates at which the individual is expected to be in the foreign country; and permitting payments to be made from the virtual financial account during the travel dates.

In yet another aspect, an electronic computing device comprises: a processing unit; and system memory, the system memory including instructions which, when executed by the processing unit, cause the electronic computing device to: receive a request to allocate an amount of money for use with a credit card of an individual in a foreign country; identify the foreign country in which the individual is to travel; identify a date for which the individual is to arrive in the foreign country; obtaining a currency exchange rate on the date at which the individual is to arrive in the foreign country; using the currency exchange rate, translate the amount of money to an equivalent amount of a foreign currency in the foreign country; identify a collaborative bank in the foreign country; allocate the amount of the foreign currency to a virtual account in the collaborative bank; permit the credit card to be used to make purchases in the foreign country using the amount of the foreign currency allocated to the virtual account; receive a notification that a purchase has been made using the credit card in the foreign country; send the notification, including details of the purchase, to the collaborative bank; receive payment from the individual for the purchases made using the credit card in the foreign country; and send the payment to the collaborative bank to reimburse the collaborative bank for payments made to merchants.

The details of one or more techniques are set forth in the accompanying drawings and the description below. Other features, objects, and advantages of these techniques will be apparent from the description, drawings, and claims.

DESCRIPTION OF THE DRAWINGS

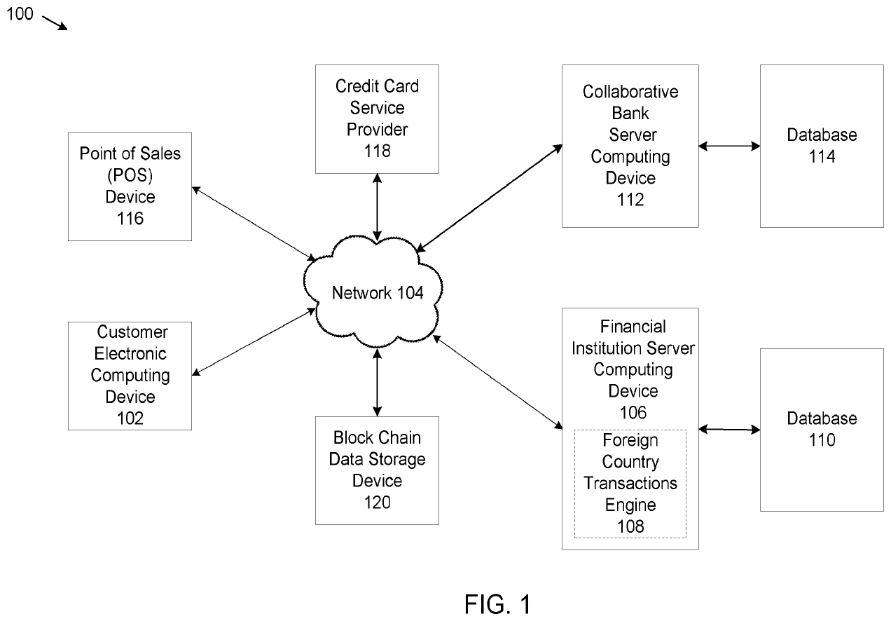

FIG. 1 shows an example system that supports using a credit card as a forex card.

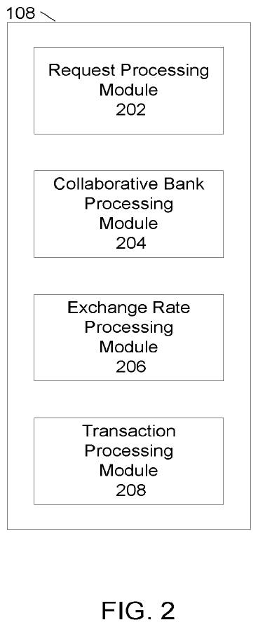

FIG. 2 shows example modules of the foreign currency transactions engine of FIG. 1.

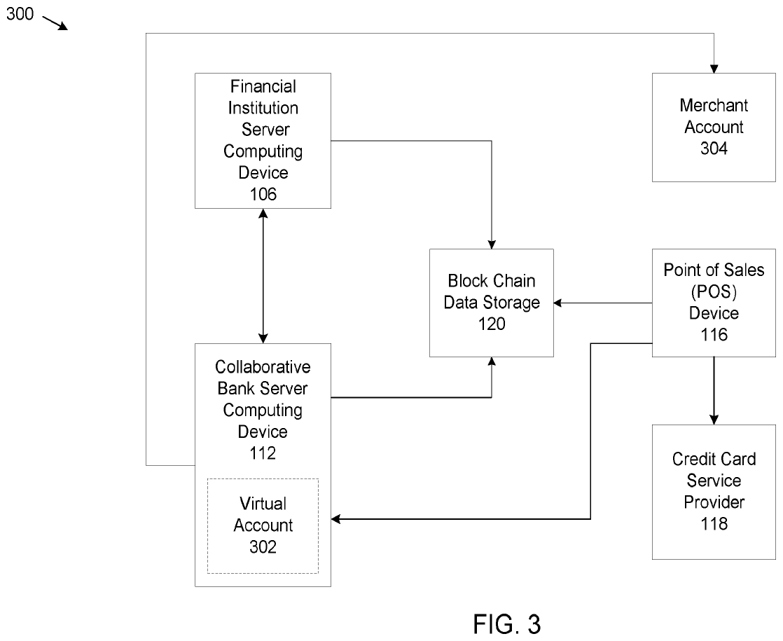

FIG. 3 shows an example schematic diagram of components of the system of FIG. 1.

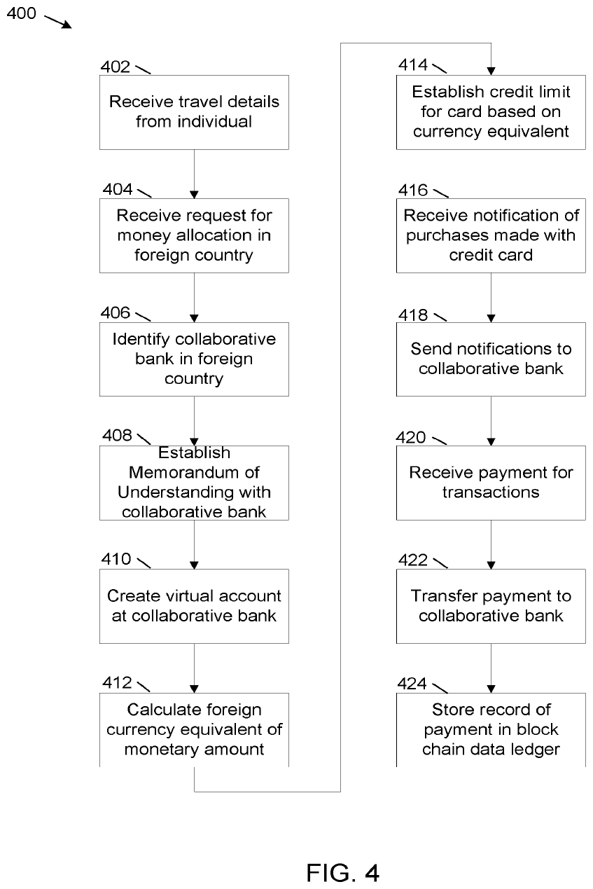

FIG. 4 shows an example method for implementing a credit card as a forex card.

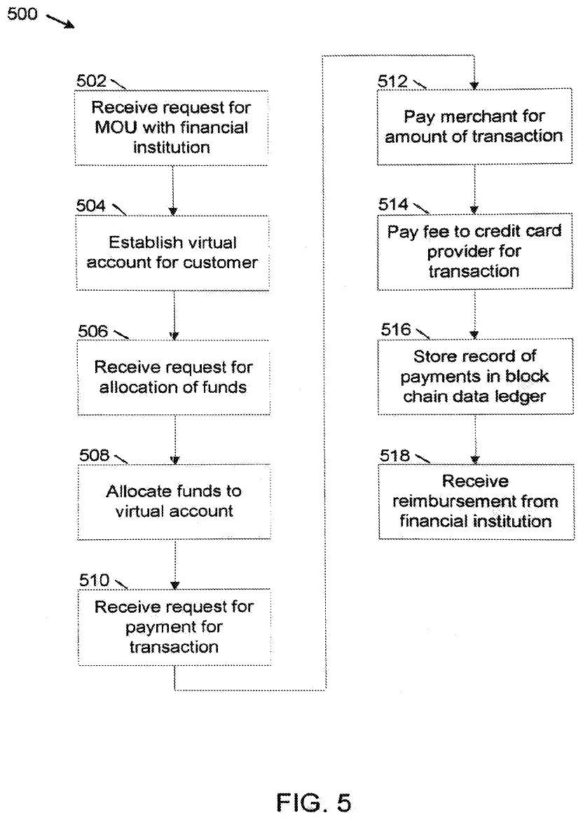

FIG. 5 shows another example method for implementing a credit card as a forex card.

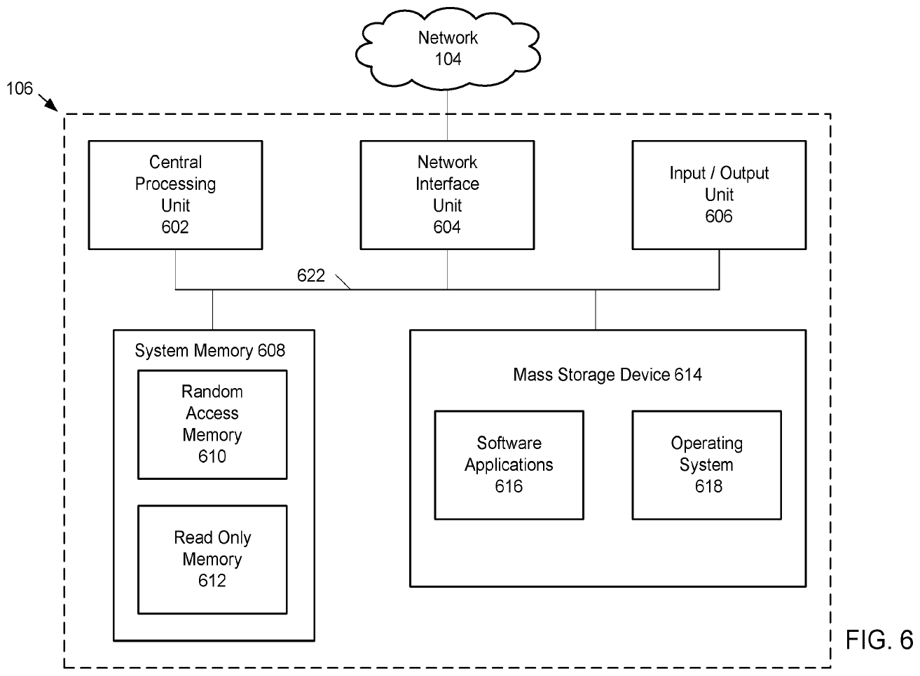

FIG. 6 shows example physical components of the financial institution server computing device of the system of FIG. 1.

### DETAILED DESCRIPTION

The present disclosure is directed to systems and methods for enabling use of a credit card of an individual as a forex card. Using the systems and methods, a virtual account for the individual can be created in a collaborative bank in a foreign country. The collaborative bank can have a relationship or agreement with a financial institution in the home country of the individual. The financial institution, for example a bank, can be one at which the individual has obtained the credit card. Funds in the home currency of the individual can be converted to a local currency of the foreign country and allocated for use with the credit card. The credit card can then be used to purchase goods and services in the foreign country using the local currency of the foreign country.

When purchases are made using the credit card in the foreign country, processing of the purchase transactions is done locally, using the virtual account at the collaborative bank. Because the processing of the transactions is performed locally, the exchange rate using the credit card is typically significantly less than if a forex card were used. In addition, overall processing fees are reduced because the processing is handled in the foreign country. The individual can use the credit card transparently in the foreign country, in the same way that the individual can use the credit card in the home country of the individual.

When the individual requests that funds in the local currency be allocated for the individual's credit card, a fixed exchange rate is applied to the funds. The fixed exchange rate is typically an exchange rate in effect at a time that the individual is expected to travel to the foreign country. Once the funds are converted into the local currency of the foreign country at the noted exchange rate, any future increases or decreases in the exchange rate do not affect the value of the local currency allocated for the credit card.

The systems and methods support the use of block chain technology to store transaction data for purchases made using the credit card. As explained in more detail later herein, when a transaction is initiated at a point of sale (POS) device and when data regarding the purchase is sent to or received from the home bank and the collaborative bank, data regarding the transaction can be stored in a block chain data ledger.

The systems and methods discussed herein are directed to a computing technology that can permit credit card transactions in a foreign country to be processed locally in the foreign country. The systems and method provides efficiencies in processing the credit card transactions. Instead of using multiple computer systems in different countries and processing messages and data between these multiple computer systems, the credit card transactions can be processed within the foreign country in which the transactions occur. Therefore, an overall time for processing a credit card transaction is decreased because fewer computer systems are involved. This results in a more efficient processing of global credit card transactions.

FIG. 1 shows an example system 100 that can support the use of a credit card of an individual as a forex card. System 100 includes a customer electronic computing device 102, a network 104, a financial institution server computing device 106, a database 110, a collaborative bank server computing device 112, a database 114, a point of sales (POS) device 116, a credit card service provider 118, and a block chain data storage device 120. Financial institution server computing device 106 includes a foreign country transactions engine 108. More, fewer, or different components are possible.

The example customer electronic computing device 102 is an electronic computing device of a customer of a financial institution, such as a bank. The electronic computing device can be one or more of a desktop computer, a laptop computer, or a mobile computing device, such as a tablet computer or a smartphone. Other electronic computing devices are possible. The customer can request using the credit card as a forex card from customer electronic computing device 102.

The example network 104 is a computer network and can be any type of wireless network, wired network and cellular network, including the Internet. Customer electronic computing device 102 can communicate with financial institution server computing device 106 using network 104.

The example financial institution server computing device 106 is a server computing device of a financial institution, such as a bank. The customer obtains the credit card from the financial institution and credit card transactions are directed to the financial institution for processing (or are processed by a credit card processor on the bank's behalf). However, as discussed in more detail later herein, when the financial institution has an agreement with a collaborative bank in a foreign country, the processing of purchase transactions in the foreign country is handled at the collaborative bank. The customer can also have one or more financial accounts at the financial institution.

As discussed in more detail later herein, financial institution server computing device 106 can receive a request from the customer at customer electronic computing device 102 to convert a specific amount of U.S. dollars to a foreign currency for use with the credit card to make purchases in the foreign country. The specific amount of U.S. dollars is converted into a local currency of the foreign country and allocated to a virtual account for the customer at the collaborative bank.

As used in this disclosure, the virtual account is a pseudo financial account of the customer in the collaborative bank. The virtual account permits the collaborative bank to process purchase transactions made by the customer in the foreign country with the credit card as if the customer had an actual financial account at the collaborative bank. Payments to merchants for purchases using the credit card in the foreign country are made from the virtual account at the collaborative bank.

The foreign country transactions engine 108 processes the request from the customer for the conversion of the U.S. dollars to the foreign currency. As discussed in more detail later herein, foreign country transactions engine 108 communicates with a collaborative bank in the foreign country and requests the establishment of a virtual account for the customer in the collaborative bank. The collaborative bank is one that that has a working relationship with the financial institution to establish virtual accounts for the customer at the collaborative bank.

Foreign country transactions engine 108 also processes a conversion of U.S. dollars to the local currency using a fixed exchange rate and also handles transaction processing of the purchase made with the credit card.

The example database 110 is a database associated with the organization of financial institution server computing device 106. Database 110 can store personal and financial information for the customer and for family members of the customer, including information regarding currency conversion using a credit card of the customer. Database 110 can be distributed over a plurality of databases. Financial institution server computing device 106 can be programmed to query (e.g. using Structured Query Language, SQL) database 110 to obtain customer information.

An example schema including, but not limited to, customer information stored in database 110 is shown below. More, fewer, or different fields are possible.
Customer name—the name of the customer;
Customer credit card number—a number that uniquely identifies the customer's credit card;
Allocation amount—an amount of U.S. dollars that are allocated to the credit card for use in the foreign country;
Currency exchange rate—number that specifies a currency exchange rate between U.S. dollars and a foreign currency at a date and time when a currency conversion occurs;
Settlement date—a date on which customer payment is due on an outstanding credit card balance;
Collaborative bank—a name of a collaborative bank in a foreign country to which the customer is to travel;
Travel location—a name of a foreign country to which the customer is to travel;
Travel dates—dates and times at which travel to the foreign country is to occur;
Purchase 1 data—a pointer to an area of memory describing a first purchase using the credit card:
Purchase description—a description of the first purchase made with the credit card in the foreign country;
Date of purchase—a date of the first purchase;
Purchase amount—a purchase price for the first purchase in the foreign currency;
Merchant name—a name of a merchant at which the first purchase was made;
Merchant identifier—a numeric or alphanumeric unique identifier for the merchant;
Merchant address—a street address for the merchant;
Purchase n data—a pointer to an area of memory describing an nth purchase made with the credit card in the foreign country;

The above schema permits the database to be queried for data such as an allocation amount for a customer and purchases made by the customer.

As an example, the following messaging format can be used between the financial institution server computing device 106 and the database 110 to obtain the base maximum credit limit for the customer.

| | |
|---|---|
| Customer ID | Allocation amount |

As an example, the database 110 can use the following messaging format in responding to such a request. In this example, an amount of U.S. dollars and a corresponding amount of foreign currency allocated to the credit card are returned in response to the request.

| | | |
|---|---|---|
| Customer ID | Dollar amount allocated to | Foreign currency amount |
| | credit card | allocated to credit card |

As another example, the following messaging format can be used to obtain the currency exchange rate used when obtaining the foreign currency amount.

| | |
|---|---|
| Customer ID | Currency exchange rate |

As an example, the database 110 can use the following messaging format in responding to such a request.

| | |
|---|---|
| Customer ID | Value of currency exchange rate |

The example collaborative bank server computing device 112 is a server computing device of a financial institution in the foreign country that has a collaborative relationship with the financial institution regarding credit cards used as a forex card. As a result of the collaborative relationship, a virtual account for the customer is setup at the collaborative bank.

When the customer uses the credit card in the foreign country, the collaborative bank processes the transaction in the foreign country. Payment to the merchant associated with the transaction is made by the collaborative bank in the local currency. The collaborative bank then gets reimbursed for the transaction by the financial institution, as discussed in more detail later herein.

The example database 114 is a database of the collaborative bank and communicates with collaborative bank server computing device 112. Database 114 can store information regarding the customer, including data regarding transactions made with the credit card in the foreign country.

The example POS device 116 is a point of sale device at a merchant location in a foreign country at which the customer makes a purchase using the credit card.

The example credit card service provider 118 is a credit card company, for example Visa. When the customer purchases an item at POS device 116, the customer uses the credit card (e.g., Visa) at POS device 116 to make the purchase.

The example block chain data storage device 120 is a digital ledger that stores transaction data for the credit card in a block chain format. The block chain data storage device 120 can comprise a plurality of distributed, peer-to-peer storage devices, for example server computing devices, that can store the transaction data.

FIG. 2 shows example modules of foreign country transactions engine 108. Foreign country transactions engine 108 includes a request processing module 202, a collaborative bank processing module 204, an exchange rate processing module 206, and a transaction processing module 208. More, fewer, or different modules are possible.

The example request processing module 202 receives a request from the customer at customer electronic computing device 102 to implement the customer's credit card as a forex card. The customer can issue the request by logging in to financial institution server computing device 106, either directly via a website of the financial institution implemented on financial institution server computing device 106 or via a software application of the financial institution accessible on customer electronic computing device 102. The request can specify a specific amount of U.S. dollars to be converted into a specific foreign currency. The request specifies the foreign currency and also can specify travel dates in a foreign country in which the credit card is to be used. As a result of the request, the request processing module 202 initiates a process to establish a virtual account for the customer in a collaborative bank of the financial institution in the foreign country in which the credit card is to be used.

The example collaborative bank processing module 204 receives the request from request processing module 202, identifies a collaborative bank of the financial institution in the foreign country and establishes a virtual account for the customer at the collaborative bank. The virtual account is established in an amount of a local currency corresponding to the requested amount of U.S. dollars for the credit card. The financial institution can enter into a memorandum of understanding (MOU) with the collaborative bank regarding the virtual account. The MOU can indicate a credit limit for credit card transactions for the customer and can also provide terms of repayment to the collaborative bank. Typically, repayment to the collaborative bank is made on or before a settlement date for payment to the credit card company, e.g. VISA, used for the transactions.

The exchange rate processing module 206 calculates a value of the local currency corresponding to the request amount of U.S. dollars for the credit card based on a current exchange rate for between U.S. dollars and the foreign currency. In an example implementation, the current exchange is an exchange rate in effect during a time period in which the customer is in the foreign country.

The example transaction processing module 208 receives a request for payment for a transaction made by the customer in the foreign country using the credit card. The request is to reimburse the collaborative bank for the amount of the transaction, in accordance with the MOU. An example transaction process is described in more detail later herein, in regard to FIG. 3.

FIG. 3 shows a schematic diagram 300 of an example implementation of a transaction sequence in a foreign country using the credit card. The implementation assumes that virtual account 302 has been setup at collaborative bank server computing device 112.

The example transaction sequence starts when the customer purchases an item using the credit card at a retail store of a merchant in the foreign country. The transaction is processed at POS device 116.

Because the use of the use of the collaborative account is transparent to the processing of the transaction, a notification of the transaction is sent to financial institution server computing device 106. Financial institution server computing device 106 checks to determine whether the credit card as a MOU associated with it. When financial institution server computing device 106 determines that a MOU is associated with the credit card, instead of processing the transaction at financial institution server computing device 106, financial institution server computing device 106 sends a notification of the transaction to collaborative bank server computing device 112.

When collaborative bank server computing device 112 receives a notification of the transaction, collaborative bank server computing device 112 processes the transaction locally in the foreign country using virtual account 302. Collaborative bank server computing device 112 transfers a payment for the transaction, in the local currency, to merchant account 304. The merchant account 304 is a financial account of a merchant at which the item was purchased.

Because the transaction is processed using virtual account 302 of collaborative bank server computing device 112, the POS transaction and payment to merchant account 304 is performed within the foreign country. As a result, fees for the transaction are minimized. The merchant is paid via virtual account 302 without the customer having an actual financial account in the foreign country.

When the customer makes payment to the financial institution for transactions made using the credit card, typically on or before the settlement date established for the credit card, financial institution server computing device 106 transfers payment for the transactions to collaborative bank server computing device 112. The payment is made in the local currency of the foreign country. When making the payment, the financial institution determines an amount of U.S. dollars corresponding to the payment in the local currency. The amount of U.S. dollars is based on the fixed exchange rate established for the customer at the time that the customer was in the foreign country.

In the implementation of system 100 shown in FIG. 3, records are maintained of different aspects of the transaction processing. The records are maintained in block chain data storage device 120. For the example implementation shown in FIG. 3, when the item is purchased at POS device 116, a record of the purchase is saved at block chain data storage device 120. Similarly, when collaborative bank server computing device 112 makes a payment for a transaction to merchant account 304 via virtual account 302, a record of the payment is saved at block chain data storage device 120, and when financial institution server computing device 106 reimburses collaborative bank server computing device 112 for payments made to merchants, a record of the reimbursement is saved at block chain data storage device 120.

FIG. 4 shows a flowchart for an example method 400 for processing a request for a virtual forex card for an individual at a financial institution in the home country of the individual. For method 400, financial institution server computing device 106 is a server computing device associated with the financial institution. Method 400 also assumes that the individual has obtained his/her credit card from the financial institution, that the financial institution bills the individual for purchases made on the credit card, and that the individual sends payments for the purchases made to the financial institution. The individual is required to send payments to the financial institution by a settlement date, typically a specific day of each month.

At operation 402, travel details are received at financial institution server computing device 106 from a customer of the financial institution at customer electronic computing device 102. The travel details are for a future trip for the customer to a foreign country.

At operation 404, a request is received from the customer to allocate money in a local currency for spending while on the trip. The amount of money to be allocated can correspond to an amount that the customer intends to spend while in the foreign country.

At operation 406, a collaborative bank is identified in the foreign country. The collaborative bank is one that can establish a collaborative banking relationship with the financial institution. The collaborative banking relationship can permit the credit card of the customer to be used as a forex card in the foreign country.

At operation 408, a memorandum of understanding (MOU) is established between the financial institution and the collaborative bank. The MOU is an agreement between the financial institution and the collaborative bank that specifies terms of a relationship between the financial institution and the collaborative bank. The terms can include such items as the establishment of a virtual account for the customer at the collaborative bank, a maximum amount of local currency that can be allocated to the virtual account, the settlement date when the collaborative bank is to be reimbursed for payments made via the virtual account, information regarding accessing credit card usage details for the customer from the financial institution, and other items.

The settlement date is a date at which a bill for purchases made by the customer while in the foreign country is to be paid. Typically, when the financial institution receives payment from the customer, the financial institution reimburses the collaborative bank for expenditures made by the collaborative bank from the virtual account. The expenditures typically comprise payments to merchants in the local currency of the foreign country for purchases made by the customer in the foreign country using the credit card.

At operation 410, a virtual account for the customer is established at the collaborative bank. The virtual account is one that permits the collaborative bank to make payments in the local currency of the foreign country to merchants to pay for items purchased by the customer using the credit card. The virtual account permits credit card transactions of the customer to be processed locally in the foreign country, as if the customer had an actual account at the collaborative bank.

At operation 412, a foreign currency equivalent of the allocated money amount is calculated. The foreign currency equivalent is calculated on a date specified by the customer or the financial institution. The date is typically a date at which the customer expects to be in the foreign country. The currency exchange rate in effect on that date is the currency exchange rate used for the calculation.

At operation 414, a credit limit is established for the customer based on the calculated foreign currency equivalent. The credit limit sets a monetary limit for credit card purchases made by the customer in the foreign country.

At operation 416, financial institution server computing device 106 receives notification of a purchase made with the credit card in the foreign country. Because the use of the credit card is transparent to merchants in the foreign country, when a purchase transaction occurs in the foreign country, the notification of the purchase transaction is sent to financial institution server computing device 106, in the same manner as notifications for any other purchase transaction made with the credit card.

At operation 418, financial institution server computing device 106 sends the notification of the purchase transaction, which includes details of the purchase transaction, to collaborative bank server computing device 112. The notification is sent to collaborative bank server computing device 112 because when financial institution server computing device 106 receives the notification, financial institution server computing device 106 checks to see whether a MOU is associated with the credit card. The MOU specifies that the processing of the transaction is to be performed locally at the collaborative bank. The processing of the transaction by the collaborative bank is discussed in more detail with respect to FIG. 5.

At operation 420, financial institution server computing device 106 receives a payment from the customer for purchases made using the credit card in the foreign country. The purchases are received by the settlement date for purchase transactions, as specified in the MOU.

At operation 422, financial institution server computing device 106 sends the payment for the purchases to collaborative bank, specifically to collaborative bank server computing device 112.

At operation 424, a record of the payment received at financial institution server computing device 106 and a record of the payment to collaborative bank server computing device 112 are stored in a block chain data ledger, for this example at block chain data storage device 120.

FIG. 5 shows a flowchart for an example method 500 for implementing a credit card as a forex card at the collaborative bank of the financial institution in the foreign country where the credit card is being used.

At operation 502, the collaborative bank receives a request for a MOU agreement with the financial institution. The MOU specifies terms for the collaborative bank processing credit card transactions of the customer in the foreign country in which the financial institution is located.

At operation 504, a virtual account is established for the customer at the collaborative bank. The virtual account permits payments to be made to merchants for purchases made by customer with the credit card in the foreign country.

At operation 506, a request for allocation of funds is received at the collaborative bank. The amount of funds to be allocated is based on an amount requested by the customer.

At operation 508, the funds are allocated to the virtual account. The amount of funds is allocated based on a currency exchange rate in effect when the customer is to be in the foreign country. The amount allocated to the virtual account is an amount in the local currency of the foreign country that is equivalent to the requested allocated amount at the currency exchange rate in effect. The amount of the local currency in the virtual account comprises a maximum credit limit for the credit card in the local currency of the foreign country.

At operation 510, the collaborative bank receives a notification from financial institution server computing device 106 of a request for payment to a merchant for a purchase transaction made by the customer in the foreign country. The notification is sent the collaborative bank per operation 420 of FIG. 4.

At operation 512, the collaborative bank pays the merchant for the amount of the purchase transaction.

At operation 514, the collaborative bank pays the credit card company (e.g. Visa) a transaction fee for the purchase. Typically, most merchants pay a fee to the credit card company for each purchase made with the credit card. For method 500, the collaborative bank subtracts the fee from the amount of the purchase, pays the fee to the credit card company and pays the amount of the purchase, less the fee to credit card company, to the merchant.

At operation 516, the collaborative bank, via collaborative bank server computing device 112, stores a record of payments made to the merchant and to the credit card company in a block chain data ledger of block chain data storage device 120.

At operation 518, the collaborative bank receives a reimbursement from the financial institution for payments made from the virtual account. The reimbursement can be received at a time of the settlement date when the financial institution receives a payment from the customer. The reimbursement can also include any fees paid from financial institution to the collaborative bank as payment to the collaborative bank for implementing the virtual account and processing the transactions at the collaborative bank.

As illustrated in the example of FIG. 6, financial institution server computing device 106 includes at least one central processing unit (“CPU”) 602, also referred to as a processor, a system memory 608, and a system bus 622 that couples the system memory 608 to the CPU 602. The system memory 608 includes a random access memory (“RAM”) 610 and a read-only memory (“ROM”) 612. A basic input/output system that contains the basic routines that help to transfer information between elements within the financial institution server computing device 106, such as during startup, is stored in the ROM 612. The financial institution server computing device 106 further includes a mass storage device 614. The mass storage device 614 is able to store software instructions and data. Some or all of the components of the financial institution server computing device 106 can also be included in customer electronic computing device 102.

The mass storage device 614 is connected to the CPU 602 through a mass storage controller (not shown) connected to the system bus 622. The mass storage device 614 and its associated computer-readable data storage media provide non-volatile, non-transitory storage for the financial institution server computing device 106. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the financial institution server computing device 106.

According to various embodiments of the invention, the financial institution server computing device 106 may operate in a networked environment using logical connections to remote network devices through the network 104, such as a wireless network, the Internet, or another type of network. The financial institution server computing device 106 may connect to the network 104 through a network interface unit 604 connected to the system bus 622. It should be appreciated that the network interface unit 604 may also be utilized to connect to other types of networks and remote computing systems. The financial institution server computing device 106 also includes an input/output controller 606 for receiving and processing input from a number of other devices, including a touch user interface display screen, or another type of input device. Similarly, the input/output controller 606 may provide output to a touch user interface display screen or other type of output device.

As mentioned briefly above, the mass storage device 614 and the RAM 610 of the financial institution server computing device 106 can store software instructions and data. The software instructions include an operating system 618 suitable for controlling the operation of the financial institution server computing device 106. The mass storage device 614 and/or the RAM 610 also store software instructions and software applications 616, that when executed by the CPU 602, cause the financial institution server computing device 106 to provide the functionality of the financial institution server computing device 106 discussed in this document. For example, the mass storage device 614 and/or the RAM 610 can store software instructions that, when executed by the CPU 602, cause the financial institution server computing device 106 to display received data on the display screen of the financial institution server computing device 106.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method implemented on an electronic computing device for using an existing credit card of an individual in a foreign country, the method comprising:
receiving, by the electronic computing device, a request to allocate an amount of money for use with the existing credit card of the individual in the foreign country;
identifying, by the electronic computing device, the foreign country in which the individual is to travel;
identifying, by the electronic computing device, a collaborative bank in the foreign country, the collaborative bank creating a virtual account for the individual;
sending, by the electronic computing device, an allocation request to the collaborative bank to allocate the amount of money for the virtual account;
receiving, by the electronic computing device, a notification for a transaction made by the individual with the existing credit card in the foreign country using the amount of money allocated to the virtual account, wherein the transaction includes one or more purchases;
determining, by the electronic computing device, that a memorandum of understanding is associated with the existing credit card;
upon determining that a memorandum of understanding is associated with the existing credit card, sending a notification of the transaction to the collaborative bank; and
storing a record in a block chain data ledger in a block chain format, the block chain format including: (i) a purchase of an item at a merchant in the foreign country, (ii) a payment made to the merchant for the purchase, and (iii) a reimbursement made to the collaborative bank for the payment to the merchant, wherein the block chain data ledger includes a block chain storage system comprising a plurality of distributed, peer-to-peer storage devices.

2. The method of claim 1, further comprising: using a fixed exchange rate, translating, by the electronic computing device, the amount of money to an equivalent amount of a foreign currency in the foreign country,
wherein the amount of money identified in the request to allocate the amount of money for the virtual account comprises the equivalent amount of the foreign currency in the foreign country.

3. The method of claim 2, wherein the fixed exchange rate is an exchange rate in effect at a date and time that the individual travels to the foreign country.

4. The method of claim 2, wherein the amount of the foreign currency comprises a credit limit for the existing credit card.

5. The method of claim 1, further comprising:
receiving, by the electronic computing device, a payment from the individual for the purchases made with the existing credit card in the foreign country; and
transferring, by the electronic computing device, the payment to the collaborative bank.

6. The method of claim 5, wherein the amount of the payment is equal to a foreign currency equivalent of the amount of the purchases made with the existing credit card.

7. The method of claim 6, further comprising: calculating, by the electronic computing device, the amount of the payment using a same currency exchange rate in effect as when the request was sent to the collaborative bank to allocate the amount of money to the virtual account.

8. The method of claim 1, the the memorandum of understanding specifying specifies terms for allocating the virtual account in the collaborative bank and for payment of funds from the financial institution to the collaborative bank.

9-11. (canceled)

12. The method of claim 11, further comprising sending, by the electronic computing device, instructions to the collaborative bank to make payment to a merchant at which the purchase transaction occurred, the payment to be made in the foreign currency.

13-20. (canceled)
